(19) United States
(12) Patent Application Publication
(10) Pub. No.: US 2026/0149195 A1
(43) Pub. Date: May 28, 2026

(54) SIGNAL TRANSMISSION STRUCTURE OF ELECTRICAL CONNECTOR AND MANUFACTURING METHOD THEREOF

(71) Applicant: Suzhou Keli Technology Development Co., Ltd., Suzhou (CN)

(72) Inventor: CHIEN HSING LAI, Suzhou (CN)

(21) Appl. No.: 18/957,767

(22) Filed: Nov. 24, 2024

(51) Int. Cl. H01R 4/58; H01R 12/53; H01R 13/405; H01R 13/50; H01R 43/20

(52) U.S. Cl. CPC H01R 4/58; H01R 12/53; H01R 13/405; H01R 13/50; H01R 43/205

(57) ABSTRACT

A signal transmission structure and a manufacturing method thereof are disclosed. The signal transmission structure includes an insulation structure, least one electrically-conductive member, and a dielectric permittivity reduction layer. The insulation structure includes an insulation joining surface, wherein a material of the insulation structure has a first dielectric permittivity. The at least one electrically-conductive member is joined to the insulation structure, wherein a signal of high frequency is transmitted in the electrically-conductive member, and the electrically-conductive member has a conductor joining surface joined to the insulation joining surface. The dielectric permittivity reduction layer is formed on the conductor joining surface and sandwiched between the conductor joining surface and the insulation joining surface, wherein the dielectric permittivity reduction layer has a second dielectric permittivity; wherein the second dielectric permittivity is smaller than the first dielectric permittivity.

### BACKGROUND OF THE INVENTION

### Field of the Invention

The invention relates to a technical field of electrical connector, and more particularly to a signal transmission structure of an electrical connector and a manufacturing method thereof.

### Description of the Related Art

Referring to FIGS. 1, 2, 3 and 4, a conventional manufacturing process of a signal transmission structure of an electrical connector is illustrated. As shown in FIG. 1, metal conductors P1 and metal conductors P2 are respectively arranged at two rows at two opposite ends of a circuit board P. The metal conductors P1 are used to mate a counterpart electrical connector, and the metal conductors P2 are used to electrically connect to wires C1 of a cable C (For example, through a soldering process), and the metal conductors P1 and the metal conductors P2 are electrically connected respectively through trances extended in the circuit board P. Then, as shown in FIG. 2, an insulation structure I is formed through a plastic injection molding process to enclose the circuit board P, and the electrically connected metal conductors P2 and the wires C1 are also enclosed thereby.

The electrical connection structure of the metal conductors P1, the metal conductors P2 and the wires C1 is used to transmit electronic signals. As the communication technology has developed to the fifth generation and is even about to enter the sixth generation, the electrical connectors are mostly used for transmission of signals at high-frequency. When signals of high-frequency are transmitted sequentially from the metal conductors P1, the traces of the circuit board P, the metal conductors P2, and the wires C1 of the cable C, reductions of signal losses and transmission delay have become important design considerations.

In the aforementioned conventional electrical connection structure, the metal conductors P2 of the circuit board P and the wires C1 of the cable C are enclosed by the insulation structure I to strengthen of the soldering structure of the wire C1 and the metal conductors P2. When signals of high frequency are transmitted in the aforementioned electrical connection structure, the signal transmission speed is governed by the following equation,

$$v = kc / √ ε$$

where v (m/s) is the signal transmission speed, k is a constant related to the arrangement of conductors, c is the light traveling speed, 3×10⁸ m/s, and ε is a dielectric permittivity of the material adjacent to the conductor.

The signal transmission speed v in the metal conductors P2 and the wires C1 is proportional to 1/√ε, and it means that the signal transmission speed is affected by the material surrounding the metal conductors P2 and the wires C1. The greater the value of dielectric permittivity ε has, the signal transmission speed v is lower. As the insulation structure I encloses the metal conductors P2 and the wires C1, the dielectric permittivity of the material of the insulation structure I may affect the signal transmission speed therein, in particular for the signals of high frequency.

### BRIEF SUMMARY OF THE INVENTION

An object of the present invention is to provide a signal transmission structure and a manufacturing method thereof, wherein the dielectric permittivity of a material adjacent to the electrically-conductive members is reduced, thereby increasing the signal transmission speed in the electrically-conductive members.

The signal transmission structure in accordance with an exemplary embodiment of the invention includes an insulation structure, least one electrically-conductive member, and a dielectric permittivity reduction layer. The insulation structure includes an insulation joining surface, wherein a material of the insulation structure has a first dielectric permittivity. The at least one electrically-conductive member is joined to the insulation structure, wherein a signal of high frequency is transmitted in the electrically-conductive member, and the electrically-conductive member has a conductor joining surface joined to the insulation joining surface. The dielectric permittivity reduction layer is formed on the conductor joining surface and sandwiched between the conductor joining surface and the insulation joining surface, wherein the dielectric permittivity reduction layer has a second dielectric permittivity; wherein the second dielectric permittivity is smaller than the first dielectric permittivity.

In another exemplary embodiment, the dielectric permittivity reduction layer is a coating layer formed by a dielectric permittivity reduction material.

In yet another exemplary embodiment, the dielectric permittivity reduction layer is a coating layer formed by a dielectric permittivity reduction material.

In another exemplary embodiment, the dielectric permittivity reduction layer is a coating layer formed by a dielectric permittivity reduction material.

In yet another exemplary embodiment, the electrically-conductive member further comprises a conductive wire of a cable electrically connected to the electrical connection portion, and the conductor joining surface comprises surfaces of the electrical connection portion and the conductive wire joined to the insulation joining surface.

In another exemplary embodiment, the electrical connection portion is a metal pad disposed on a circuit board.

In yet another exemplary embodiment, the insulation structure encloses the electrical connection portion, the conductive wire and the circuit board, and the dielectric permittivity reduction layer is formed on the surfaces of the electrical connection portion, the conductive wire and the circuit board contacting the insulation structure.

The manufacturing method of the signal transmission structure in accordance with an exemplary embodiment of the invention includes the following steps: providing at least one electrically-conductive member having a conductor joining surface; forming a dielectric permittivity reduction layer on the conductor joining surface; forming an insulation structure on the electrically-conductive member, wherein the insulation structure has an insulation joining surface joined to the conductor joining surface; wherein the dielectric permittivity reduction layer is sandwiched between the conductor joining surface and the insulation joining surface, and the insulation structure has a first dielectric permittivity, and the dielectric permittivity reduction layer has a second dielectric permittivity smaller than the first dielectric permittivity.

In another exemplary embodiment, the dielectric permittivity reduction layer is formed on the conductor joining surface by coating a dielectric permittivity reduction material thereon.

In yet another exemplary embodiment, the dielectric permittivity reduction material comprises a solute comprising a polymer containing fluorine and a solvent containing fluorine, and the solute has a concentration of 3% to 30%, and the solvent has a concentration of 70% to 97%.

In another exemplary embodiment, the electrically-conductive member comprises an electrical connection portion of a terminal of the electrical connector and a conductive wire of a cable, and the conductive wire is electrically connected to the electrical connection portion.

In yet another exemplary embodiment, the electrical connection portion is a metal pad disposed on a circuit board, and the insulation structure encloses the electrical connection portion, the conductive wire and the circuit board, and the dielectric permittivity reduction layer is formed on the surfaces of the electrical connection portion, the conductive wire and the circuit board contacting the insulation structure.

The electrical connector signal transmission structure of the present invention includes the dielectric permittivity reduction layer coated on the conductor joining surface. The dielectric permittivity reduction layer has a dielectric permittivity smaller than that of the material originally enclosing the electrically conductive members, thereby increasing the signal transmission speed in the electrically conductive member.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIGS. 1 and 2 are schematic views of a manufacturing process of a conventional signal transmission structure of an electrical connector;

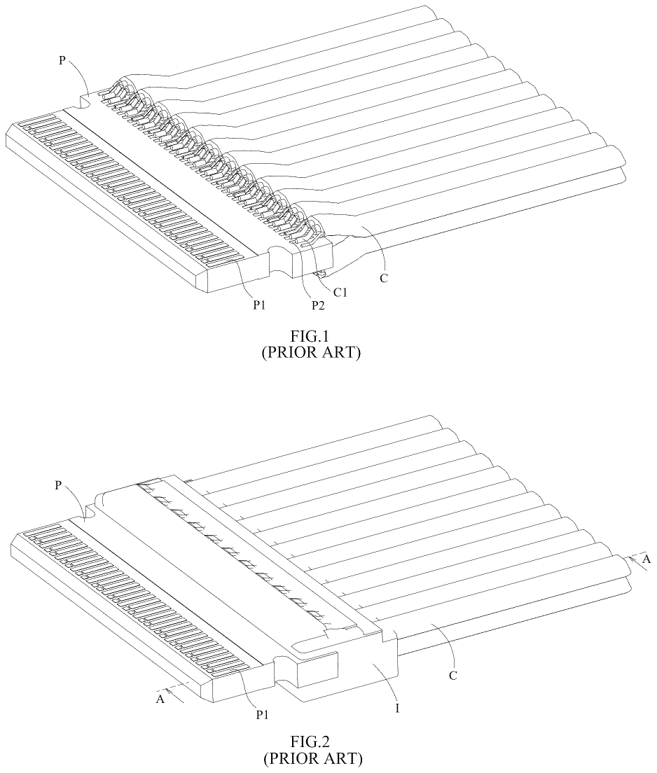

FIG. 3 is a cross section along a line A-A of FIG. 2;

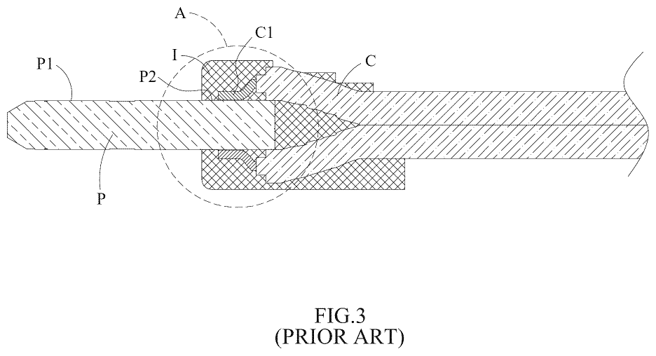

FIG. 4 is an enlarged view of a portion A of FIG. 3;

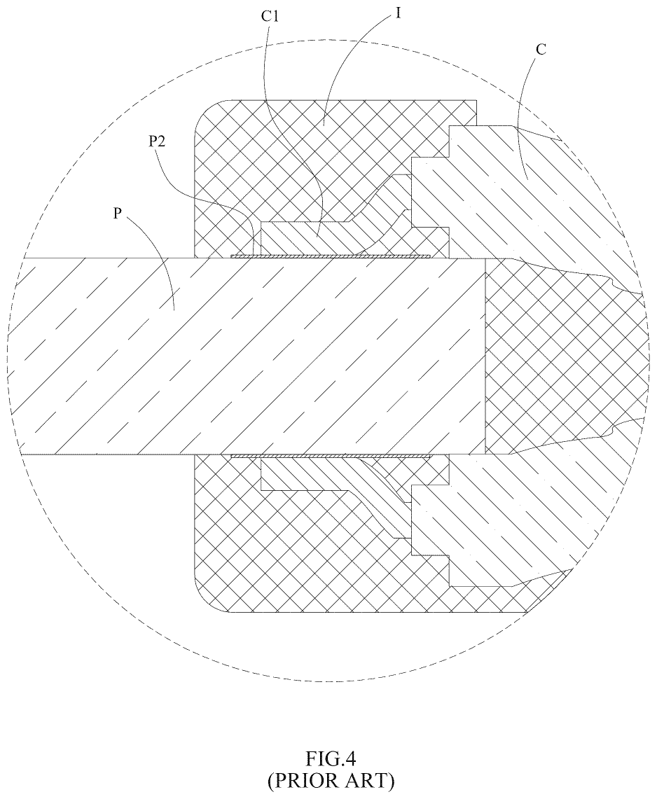

FIGS. 5, 6 and 7 are schematic views of an embodiment of a manufacturing method of a signal transmission structure of an electrical connector of the present invention;

FIG. 8 is a cross section along a line B-B of FIG. 7;

FIG. 9 is an enlarged view of a portion B of FIG. 8; and

FIG. 10 is a cross section of an embodiment of a signal transmission structure of an electrical connector of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

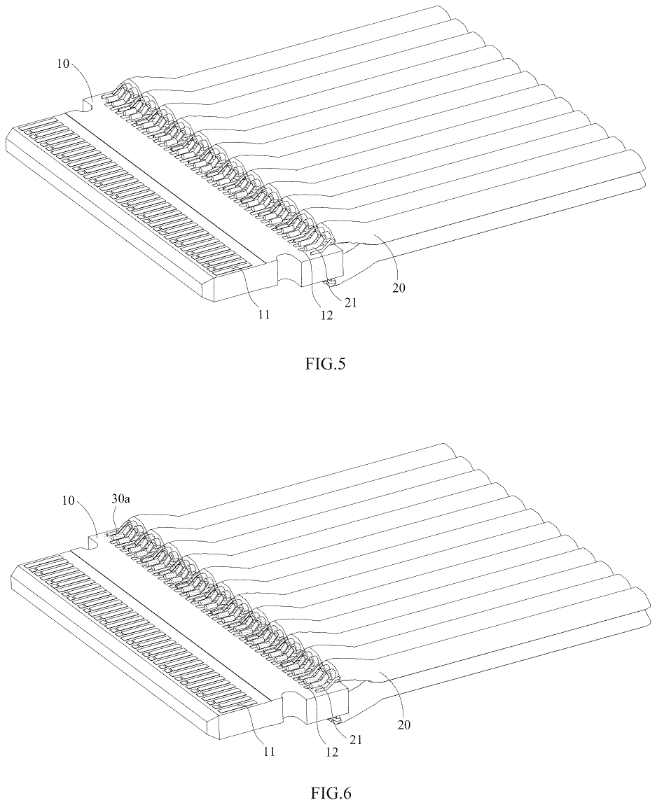

Referring to FIGS. 5, 6 and 7, an embodiment of a manufacturing method of a signal transmission structure of an electrical connector of the present invention.

As shown in FIG. 5, a plurality of mating conductors 11 and a plurality of soldering conductors 12 are respectively provided at two opposite ends of a circuit board 10. The mating conductors 11 and the soldering conductors 12 are metal pads formed on the circuit board 10. The mating conductors 11 are metal pads arranged in a row for mating terminals of a counterpart electrical connector. The soldering conductors 12 are metal pads arranged in a row for electrical connection with electronic components outside the electrical connector. In the present embodiment, the soldering conductors 12 are electrically connected to wires 21 of a cable 20. The mating conductors 11 and the soldering conductors 12 are respectively electrically connected via traces in the circuit board 10. The soldering conductors 12 of this embodiment is electrically connected to a plurality of the wires 21 of the cable 20 through a soldering process. The wires 21 are joined to the soldering conductors 12 after the soldering process, wherein the soldering conductors 12 and the wires 21 soldered thereon are the electrically-conductive members considered in the present embodiment. The exposed surfaces of the welding conductors 12, the wires 21 and the solder joining them form a conductor joining surface 10a.

As shown in FIG. 6, a dielectric permittivity reduction material 30a is coated on the circuit board 10 and the conductor joining surface 10a. The dielectric permittivity reduction material 30a is cured to form a dielectric permittivity reduction layer 30 on the conductor joining surface 10a. The dielectric permittivity reduction material 30a includes a solute including a polymer containing fluorine, and a solvent containing fluorine. The solute has a concentration (wt %) of 3% to 30%, and the solvent has a concentration (wt %) of 70% to 97%. The dielectric permittivity reduction material 30a is cured through a drying process.

As shown in FIG. 7, an insulation structure 40 is formed on the circuit board 10 through a plastic injection molding process, wherein the insulation structure 40 encloses the conductor joining surface 10a including the surfaces of the soldering conductors 12 and the wires 21 where the dielectric permittivity reduction layer 30 is formed. The insulation structure 40 has an insulation joining surface 40a joining the conductor joining surface 10a. The dielectric permittivity reduction layer 30 is sandwiched between the conductor joining surface 10a and the insulation joining surface 40a.

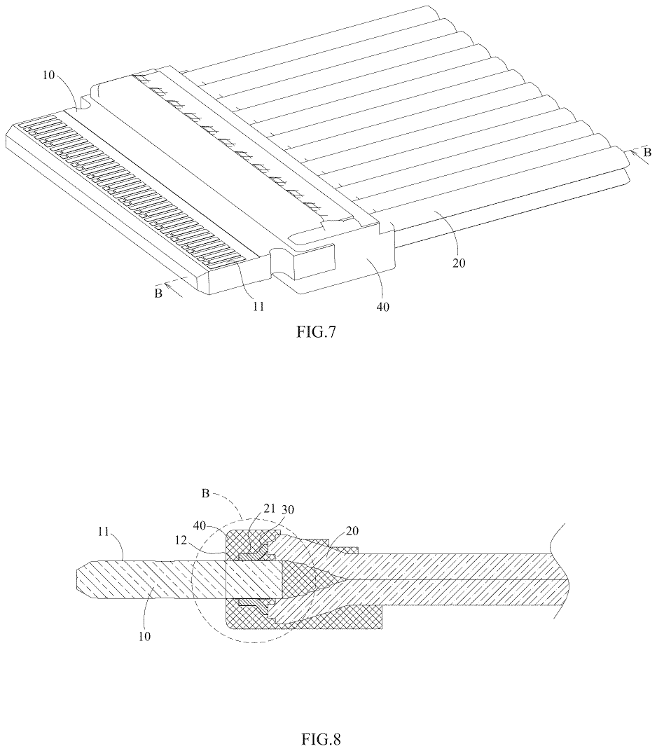

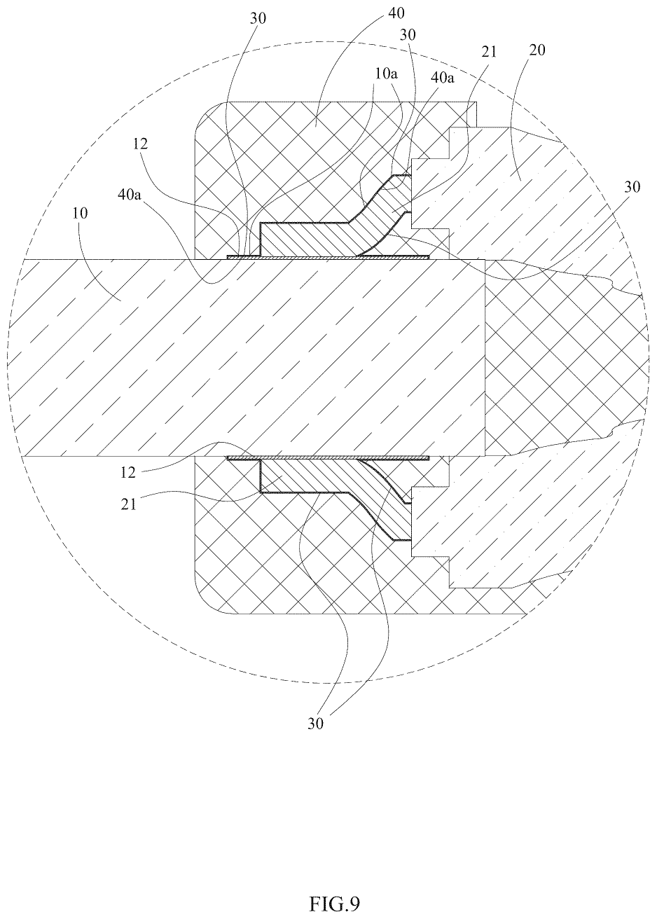

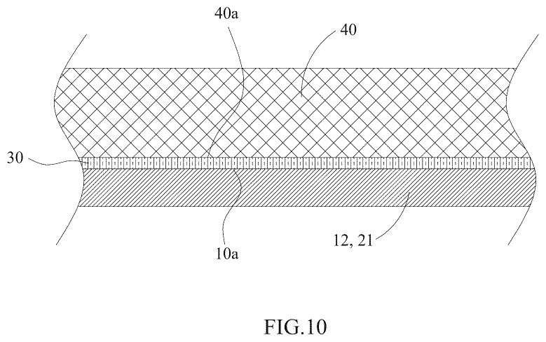

Referring to FIGS. 8, 9 and 10, an embodiment of a signal transmission structure of an electrical connector of the present invention is illustrated. The dielectric permittivity reduction layer 30 is sandwiched between the conductor joining surface 10a and the insulation joining surface 40a, whereby the exposed conductor joining surface 10a constituted from the soldering conductors 12 and the wires 21 does not directly contact the insulation joining surface 40a due to the dielectric permittivity reduction layer 30. The insulation structure 40 is made of a plastic material having a first dielectric permittivity, and the first dielectric permittivity has a value ranging from 2.3 to 4.5, for example the material PP is 2.3 and the material PVC is 4.0. The dielectric permittivity reduction layer 30 has a second dielectric permittivity having a value smaller than than 2. In this embodiment, the value of the second dielectric coefficient is 1.5 to 1.8. In this way, as the dielectric permittivity reduction layer 30 having a lower dielectric permittivity, the dielectric permittivity reduction layer 30 can reduce the capacitive effect between the soldering structure (the soldering conductors 12 and the wires 21) and the insulation structure 40 when signals of high-frequency are transmitted in the soldering conductors 12 and the wires 21, whereby signal transmission speed is creased.

Although the present embodiment the soldering conductors formed on the circuit board is used as an example for the description of the electrically-conductive member, the invention is not limited thereto. Electrical connectors with elastic arm-shaped terminals are also applicable, and a soldering portion of the elastic arm-shaped terminal soldering to a wire of a cable or a securing portion of the elastic arm-shaped terminal joined to an insulation structure can also be applicable.

The electrical connector signal transmission structure of the present invention includes the dielectric permittivity reduction layer coated on the conductor joining surface. The dielectric permittivity reduction layer has a dielectric permittivity smaller than that of the material originally enclosing the electrically conductive members, thereby increasing the signal transmission speed in the electrically conductive member.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A signal transmission structure of an electrical connector, comprising:
an insulation structure comprising an insulation joining surface, wherein a material of the insulation structure has a first dielectric permittivity;
at least one electrically-conductive member joined to the insulation structure, wherein a signal of high frequency is transmitted in the electrically-conductive member, and the electrically-conductive member has a conductor joining surface joined to the insulation joining surface; and
a dielectric permittivity reduction layer formed on the conductor joining surface and sandwiched between the conductor joining surface and the insulation joining surface, wherein the dielectric permittivity reduction layer has a second dielectric permittivity;
wherein the second dielectric permittivity is smaller than the first dielectric permittivity.

2. The signal transmission structure as claimed in claim 1, wherein the dielectric permittivity reduction layer is a coating layer formed by a dielectric permittivity reduction material.

3. The signal transmission structure as claimed in claim 2, wherein the dielectric permittivity reduction material comprises fluorine.

4. The signal transmission structure as claimed in claim 1, wherein the electrically-conductive member comprises an electrical connection portion of a terminal of the electrical connector.

5. The signal transmission structure as claimed in claim 4, wherein the electrically-conductive member further comprises a conductive wire of a cable electrically connected to the electrical connection portion, and the conductor joining surface comprises surfaces of the electrical connection portion and the conductive wire joined to the insulation joining surface.

6. The signal transmission structure as claimed in claim 5, wherein the electrical connection portion is a metal pad disposed on a circuit board.

7. The signal transmission structure as claimed in claim 6, wherein the insulation structure encloses the electrical connection portion, the conductive wire and the circuit board, and the dielectric permittivity reduction layer is formed on the surfaces of the electrical connection portion, the conductive wire and the circuit board contacting the insulation structure.

8. A manufacturing method of a signal transmission structure for an electrical connector, comprising:
providing at least one electrically-conductive member having a conductor joining surface;
forming a dielectric permittivity reduction layer on the conductor joining surface;
forming an insulation structure on the electrically-conductive member, wherein the insulation structure has an insulation joining surface joined to the conductor joining surface;
wherein the dielectric permittivity reduction layer is sandwiched between the conductor joining surface and the insulation joining surface, and the insulation structure has a first dielectric permittivity, and the dielectric permittivity reduction layer has a second dielectric permittivity smaller than the first dielectric permittivity.

9. The manufacturing method as claimed in claim 8, wherein the dielectric permittivity reduction layer is formed on the conductor joining surface by coating a dielectric permittivity reduction material thereon.

10. The manufacturing method as claimed in claim 9, wherein the dielectric permittivity reduction material comprises a solute comprising a polymer containing fluorine and a solvent containing fluorine, and the solute has a concentration of 3% to 30%, and the solvent has a concentration of 70% to 97%.

11. The manufacturing method as claimed in claim 9, wherein the electrically-conductive member comprises an electrical connection portion of a terminal of the electrical connector and a conductive wire of a cable, and the conductive wire is electrically connected to the electrical connection portion.

12. The manufacturing method as claimed in claim 9, wherein the electrical connection portion is a metal pad disposed on a circuit board, and the insulation structure encloses the electrical connection portion, the conductive wire and the circuit board, and the dielectric permittivity reduction layer is formed on the surfaces of the electrical connection portion, the conductive wire and the circuit board contacting the insulation structure.
